(19) United States
(12) Patent Application Publication
(10) Pub. No.: US 2006/0115286 A1
(43) Pub. Date: Jun. 1, 2006

(54) Electrophotographic image forming apparatus, and toner, process cartridge and image forming method therefor

(76) Inventors: Takeshi Uchitani, Kamakura-shi (JP); Ken Amemiya, Nerima-ku (JP); Toshio Koike, Kawasaki-shi (JP); Hiroshi Ono, Ota-ku (JP); Takatsugu Fujishiro, Taito-ku (JP); Tokuya Ojimi, Kawasaki-shi (JP); Yuji Arai, Kawasaki-shi (JP); Masanori Kawasumi, Yokohama-shi (JP); Takuji Yoneda, Ota-ku (JP); Haruji Mizuishi, Ota-ku (JP); Masaharu Yokono, Fujisawa-shi (JP); Masami Tomita, Numazu-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/287,421

(22) Filed: Nov. 28, 2005

(30) Foreign Application Priority Data
Nov. 30, 2004 (JP) 2004-345971
Jan. 31, 2005 (JP) 2005-022453

(51) Int. Cl. G03G 15/02

(52) U.S. Cl. 399/50

(57) ABSTRACT

An image forming apparatus including an image bearing member configured to bear an electrostatic latent image; a charging device configured to charge the image bearing member by applying a DC voltage overlapped with an AC voltage to the image bearing member; an AC current detector configured to detect an AC current flowing through the image bearing member on a ground side of the image bearing member; a light irradiating device configured to irradiate the charged image bearing member with imagewise light to form the electrostatic latent image on the image bearing member; a developing device configured to develop the electrostatic latent image with a developer comprising a toner to form a toner image on the image bearing member; a transferring device configured to transfer the toner image onto a receiving material; and a cleaning device configured to clean a surface of the image bearing member.

### BACKGROUND OF THE INVENTION

1. Field of the Invention

The present invention relates to an electrophotographic image forming apparatus, and more particularly to an electrophotographic image forming apparatus having a charging device which charges an image bearing member using a DC voltage overlapped with an AC voltage. In addition, the present invention also relates to a toner, a process cartridge and image forming method.

2. Discussion of the Background

Electrophotographic image forming apparatus typically use an image forming method including the following processes.
(1) charging a photoreceptor serving as an image bearing member such that the photoreceptor has a charge having a predetermined polarity (charging process);
(2) irradiating the charged photoreceptor with imagewise light to forman electrostatic latent image on the photoreceptor (light irradiating process);
(3) developing the electrostatic latent image with a developer including a toner having a charge with the same polarity as that of the electrostatic latent image to form a toner image on the photoreceptor (developing process);
(4) transferring the toner image onto a receiving material optionally via an intermediate transfer medium (transferring process);
(5) fixing the toner image on the receiving material upon application of heat and pressure (fixing process); and
(6) removing toner particles, which remain on the photoreceptor even after the toner image is transferred, with a cleaning member such as cleaning blades and cleaning brushes (cleaning process)

In the charging process, contact charging methods in which an electroconductive charging roller is set on the surface of the photoreceptor while applying a voltage thereto or short range charging methods in which an electroconductive charging roller applies a voltage to a photoreceptor while a small gap is formed between the surface of the charging roller and the surface of the photoreceptor are typically used. This is because these charging methods have advantages in that the amount of ozone produced in the charging process is relatively small and the applied voltage is relatively low compared to the amount of ozone produced by corona charging methods such as corotron and scorotron charging methods.

In order to uniformly charge the surface of a photoreceptor, DC/Ac charging methods in which a DC voltage overlapped with an AC voltage is applied to the photoreceptor are typically used. The charging methods have a drawback in that the electric current needed for charging a photoreceptor to a predetermined voltage is relatively large compared to DC charging methods using only a DC voltage.

When a roller is used for contact charging methods and short range charging methods, problems in that the potential of the charged photoreceptor decreases or varies due to contamination of the charging roller and thereby undesired images such as background fouling and vertical black streak images are formed occur after repeated charging operations. In this regard, the DC/AC charging methods have greater margin for such problems than the DC charging methods. Therefore, electrophotographic image forming apparatus cannot stop using the DC/AC charging methods in consideration of image qualities after long repeated use.

Published unexamined Japanese patent application No. (hereinafter referred to as JP-A) 2002-108059 discloses a short range DC/AC charging method in which a DC voltage overlapped with an AC voltage is applied to an image bearing member with a charging member with a predetermined gap therebetween, wherein each of the DC and AC voltages is controlled so as to be a predetermined voltage.

JP-A 2001-109238 discloses a DC/AC charging method in which an AC voltage is applied such that the peak-to-peak voltage (Vpp) thereof is twice the discharge starting voltage.

When the applied AC voltage is excessively high, a filming problem in that a film of toner and the like is formed on the surface of the photoreceptor (or the margin for the film forming problem decreases) and thereby the life of the photoreceptor is shortened occurs. Therefore, it is necessary to severely check and control the AC current.

In addition, JP-A 2003-302813 discloses an image forming apparatus which uses two or more kinds of AC emitting devices and a detector detecting the alternating current to prevent occurrence of defective charging and increase of the discharge current even when any combinations of a process cartridge and an image forming apparatus are used.

When DC/AC charging methods are used, a problem in that a film of toner and the like is formed on the surface of a photoreceptor is caused. This problem is difficult to solve. In attempting to solve the filming problem, a cleaning device having a cleaning blade and a cleaning roller on which an abrasive is adhered; and a cleaning device having both a cleaning blade for removing toner particles from the surface of the photoreceptor and another cleaning blade for removing the film formed on the photoreceptor, have been proposed. However, the abrasive adhered to the surface of the cleaning roller is easily released therefrom, and therefore the cleaning device cannot be used for a long period of time. In addition, the cleaning device having two cleaning blades becomes large in size and thereby a compact image forming apparatus cannot be provided. Therefore these cleaning devices cannot be practically used.

Further, when the length of a cable connecting a power source of the charging device and a charging member (such as rollers) is long, a current is generated in the cable due to stray capacitance of the cable. Therefore, a problem in that the current used for charging cannot be strictly detected due to the current caused by the stray capacitance. In addition, the current changes depending on the setting position of the alternating current detector. Further, the stray capacitance changes when the environmental conditions and/or the arrangement of the cable are changed, and therefore it is hard to measure the current caused by the stray capacitance. Namely, it is difficult to detect and control the alternating current by this method.

Because of these reasons, a need exists for an image forming apparatus which used a DC/AC charging method and which can produce high quality images without causing the filming problem for a long period of time by precisely detecting the alternating current of the AC voltage used for charging an image bearing member.

### SUMMARY OF THE INVENTION

The image forming apparatus of the present invention includes an image bearing member which is grounded and which is configured to bear an electrostatic latent image thereon; a charging device configured to apply a DC voltage overlapped with an AC voltage to the surface of the image bearing member as a charge bias to charge the image bearing member; an AC current detector configured to detect an AC current flowing through the image bearing member when the charge bias is applied; a light irradiating device configured to irradiate the charged image bearing member with imagewise light to form the electrostatic latent image on the image bearing member; a developing device configured to develop the electrostatic latent image with a developer including a toner to form a toner image on the image bearing member; a transferring device configured to transfer the toner image onto a receiving material optionally via an intermediate transfer medium; and a cleaning device configured to clean the surface of the image bearing member, wherein the AC current detector detects the AC current on a ground side of the image bearing member.

The image forming apparatus preferably includes a controller which performs an AC voltage controlling operation in which a plurality of constant-voltage alternating peak-to-peak voltages having different voltages are applied to the charging device one by one while checking the respective currents to determine a minimum AC current which is smallest among currents being not lower than a threshold current, above which a potential of the charged image bearing member is substantially constant; and then the AC voltage applied to the charging device is set to an AC voltage corresponding to the minimum AC current. Alternatively, the controller may perform an AC voltage controlling operation in which a plurality of 1-cycle AC currents are checked when the AC voltage is applied, to determine a minimum AC current among the plurality of 1-cycle AC currents; and then the AC voltage applied to the charging device is adjusted so as to be an AC voltage such that the minimum AC current is not lower than a threshold AC current, below which the toner image has background fouling.

The AC voltage setting operation is preferably performed when an absolute humidity of air surrounding the charging device is changed. In addition, the AC voltage setting operation is preferably performed when the toner image is not formed for a predetermined time. Further, the AC voltage setting operation is performed after the toner image is formed on a predetermined number of sheets of the receiving material.

It is preferable that the image forming apparatus preferably includes a lubricant applicator configured to apply a lubricant such as fatty acid metal salts and fluorine containing materials to the surface of the image bearing member. The lubricant applicator preferably includes a brush roller configured to scrape a molded piece of the lubricant and then apply the scraped lubricant to the surface of the image bearing member. The toner may include a lubricant. The lubricant is preferably a fatty acid metal salt or a fluorine containing material.

The toner for use in the image forming apparatus preferably has a volume average particle diameter (Dv) of from 3 to 8 μm, and a ratio (Dv/Dn) of the volume average particle diameter (Dv) to the number average particle diameter (Dn) of from 1.00 to 1.40. In addition, the toner preferably has a shape factor SF-1 of from 100 to 180 and another shape factor SF-2 of from 100 to 180. Further, the toner preferably satisfies the following relationships:
0.5≦(r2/r1)≦1.0 and 0.7≦(r3/r2)≦1.0,
wherein r1, r2 and r3 represent the average major axis particle diameter, the average minor axis particle diameter and the average thickness of particles of the toner, wherein r3≦r2≦r1.

The toner is preferably prepared by a method including: preparing a toner composition liquid in which at least a polyester prepolymer having a functional group having a nitrogen atom, a polyester, a colorant and a release agent are dissolved or dispersed in an organic solvent; and subjecting the toner composition liquid to a crosslinking reaction and/or an extension reaction (a molecular chain growing reaction) in an aqueous medium.

As another aspect of the present invention, a toner for use in the image forming apparatus mentioned above is also provided which has a volume average particle diameter (Dv) of from3 to 8 μm, and a ratio (Dv/Dn) of the volume average particle diameter (Dv) to the number average particle diameter (Dn) of from 1.00 to 1.40. In addition, the toner preferably has a shape factor SF-1 of from 100 to 180 and another shape factor SF-2 of from 100 to 180. Further, the toner preferably satisfies the following relationships:
0.5≦(r2/r1)≦1.0 and 0.7≦(r3/r2)≦1.0,
wherein r1, r2 and r3 represent the average major axis particle diameter, the average minor axis particle diameter and the average thickness of particles of the toner, wherein r3≦r2≦r1.

As yet another aspect of the present invention, a process cartridge is provided which includes at least an image bearing member which is grounded and which is configured to bear an electrostatic latent image thereon; a charging device configured to apply a DC voltage overlapped with an AC voltage to the surface of the image bearing member as a charge bias to charge the image bearing member; an AC current detector configured to detect an AC current flowing through the image bearing member when the charge bias is applied, wherein the image bearing member, the charging member and the AC current detector are unitized.

As a further aspect of the present invention, an image forming method is provided which includes: applying a DC voltage overlapped with an AC voltage to an image bearing member to charge the image bearing member; detecting an AC current on a ground side of the image bearing member; irradiating the charged image bearing member with imagewise light to form an electrostatic latent image on the surface of the image bearing member; and developing the electrostatic latent image with a developer including a toner to form a toner image on the surface of the image bearing member.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

FIG. 1 is a schematic view illustrating an embodiment of the image forming apparatus of the present invention;

FIG. 2 is a schematic view illustrating one of image forming units of the image forming apparatus illustrated in FIG.1;

FIG. 3 is a schematic view illustrating the cross section of the charging roller used for the image forming apparatus illustrated in FIG. 1;

FIG. 4 is a schematic view illustrating a power supplying circuit and an AC current detector of the charging device used for the image forming apparatus illustrated in FIG. 1;

FIG. 5 is a graph illustrating variation of an AC current flowing the charging roller;

FIG. 6 is a graph illustrating relationship between the minimum AC current and the absolute humidity of air surrounding the charging roller;

FIG. 7 is a graph illustrating the effect of a lubricant (zinc stearate) on film formation on a photoreceptor;

FIGS. 8A and 8B are schematic views for explaining how to determine the shape factors SF-1 and SF-2; and

FIGS. 9A-9C are schematic views for explaining the major axis diameter (r1), the minor axis diameter (r2) and the height (r3) of a toner particle.

### DETAILED DESCRIPTION OF THE INVENTION

The present invention will be explained referring to drawings.

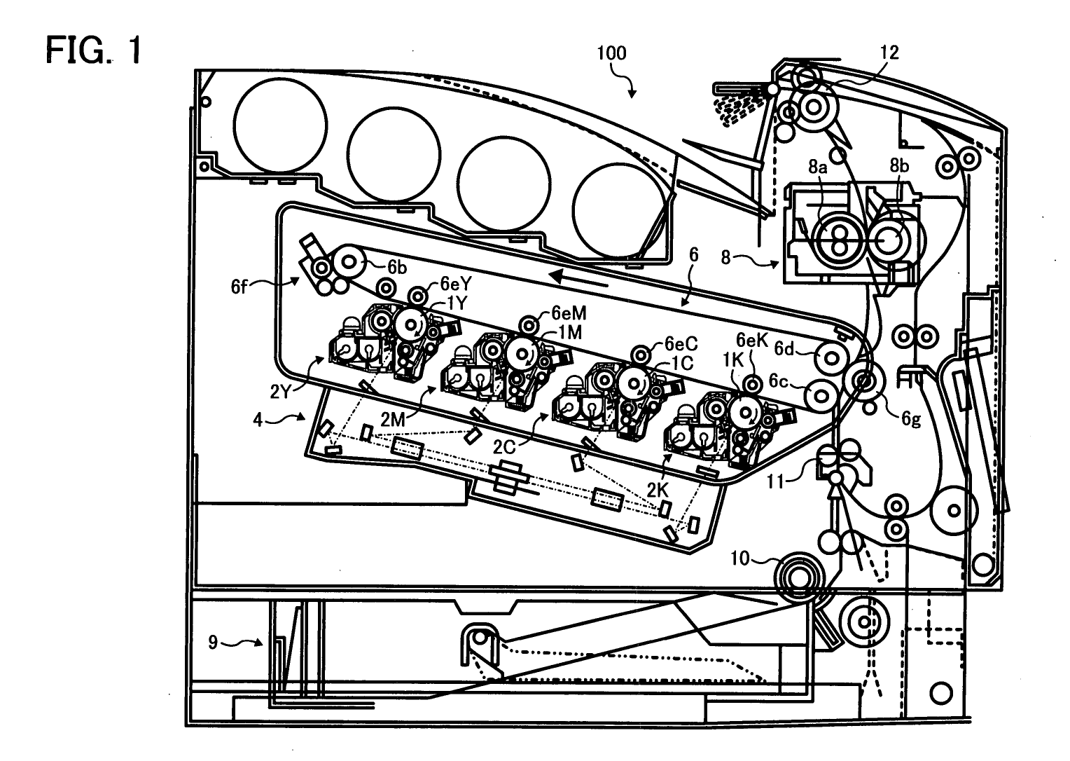

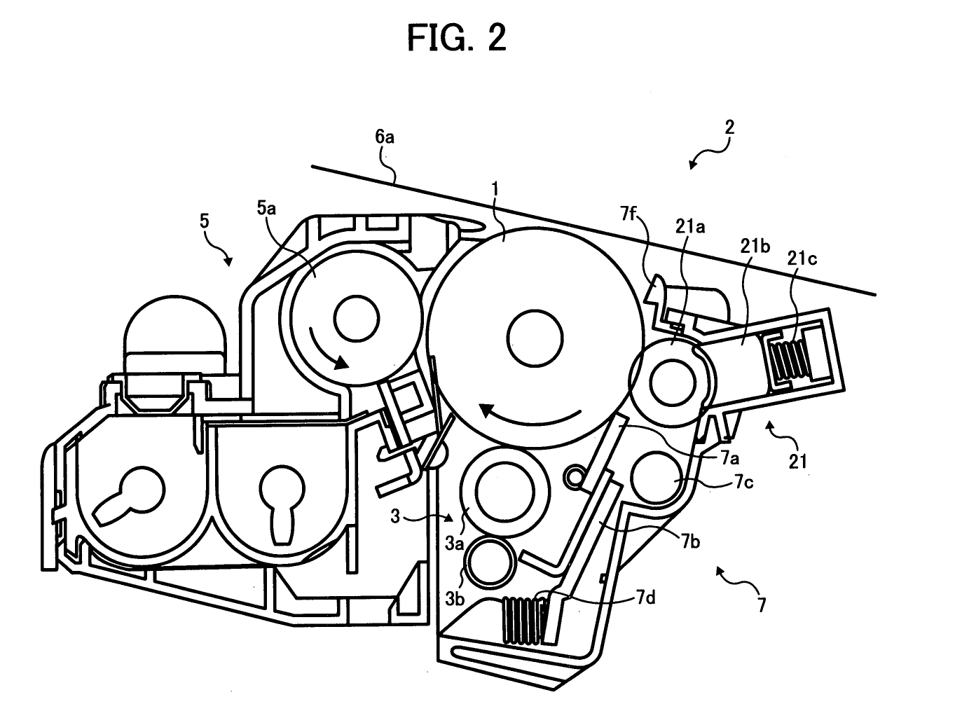

FIG. 1 is a schematic view illustrating an embodiment of the image forming apparatus of the present invention. An image forming apparatus 100 is a tandem-type color image forming apparatus including yellow, magenta, cyan and black color image forming units 2 (i.e., 2Y, 2M, 2C and 2K), which form yellow (Y), magenta (M), cyan (C) and black (K) color toner images, respectively. The color image forming units include respective photoreceptors 1 (i.e., 1Y, 1M, 1C and 1K), each of which is rotated in a direction indicated by an arrow as illustrated in FIG. 2 while contacted with an intermediate transfer belt 6a of a transferring device 6.

FIG. 2 is a schematic view illustrating one of the image forming units 2 having the photoreceptor 1. Since the four image forming units have the same configuration, the explanation is performed while removing a character (i.e., Y, M, C and K) from the reference number 1 (photoreceptor). As illustrated in FIG. 2, a developing device 5 configured to develop a latent image with a developer including a toner to form a toner image on the photoreceptor 1, a lubricant applicator 21 configured to apply a lubricant to the surface of the photoreceptor 1, a cleaning device 7 configured to remove toner remaining on the surface of the photoreceptor 1 and a charging device 3 configured to charge the photoreceptor 1 are arranged along the photoreceptor 1.

The configuration of the image forming apparatus 100 will be explained referring to FIGS. 1 and 2.

The developing device 5 includes a developing roller 5a, a portion of which is projected from an opening of a casing of the developing device 5. Although, in this embodiment the developing device develops a latent image with a two component developer including a toner and a carrier, the developer is not limited thereto and a one component developer including no carrier can also be used. The developing device 5 contains a color toner which is fed from a toner bottle. The developing roller 5a includes a fixed magnet roller serving as magnetic field generating means and a developing sleeve which is rotated around the magnet roller. The carrier on the developing sleeve is erected (i.e., forms a magnetic brush) due to the magnetic force of the magnet roller and is fed to a developing region at which the developing roller 5a faces the photoreceptor 1. In the developing region, the developing roller 5a moves in a direction indicated by an arrow at a speed faster than that of the photoreceptor 1. The magnetic brush rubs the surface of the photoreceptor 1 and thereby the charged toner particles adhered to the carrier particles are transferred to the electrostatic latent image, resulting in formation of a color toner image. In this case, a developing bias is applied to the developing roller 5a by a power source (not shown), and thereby an electric field (i.e., a development electric field) is formed in the developing region.

The intermediate transfer belt 6a of the transferring device 6 is an endless belt which is rotated in a direction indicated by an arrow while tightly stretched by three support rollers 6b, 6c and 6d. The color toner images formed on the photoreceptors 1 are electrostatically transferred onto the surface of the intermediate transfer belt 6a so as to be overlaid. In this case, a transfer method using a transfer roller is preferably used because of being superior to a method using a transfer charger in toner scattering. Specifically, primary transfer rollers 6eY, 6eM, 6eC and 6eK are arranged so as to face the respective photoreceptors 1Y, 1M, 1C and 1K while pressing the intermediate transfer belt 6a to the respective photoreceptors. Thus, four primary transferring regions are formed.

When toner images are transferred onto the intermediate transfer belt 6a, a positive bias is applied to the primary transfer rollers 6e, thereby forming an electric field (i.e., a transfer electric field) on each primary transferring region. Therefore, toner images on the photoreceptors 1 are electrostatically transferred to the intermediate transfer belt 6a.

A belt cleaning device 6f is arranged in the vicinity of the intermediate transfer belt 6a to remove (and collect) toner particles remaining on the surface of the intermediate transfer belt 6a. The belt cleaning device 6f removes and collects toner particles on the surface of the intermediate transfer belt 6a using a fur brush and a blade. The thus collected toner particles are fed from the belt cleaning device 6f to a waste toner tank (not shown) using a feeding device (not shown).

A secondary transfer roller 6g is arranged so as to be contacted with the intermediate transfer belt 6a and to face the support roller 6d. Thus, a secondary transfer region is formed between the secondary transfer roller 6g and the intermediate transfer belt 6a, and the color toner images overlaid on the intermediate transfer belt 6a are transferred onto a sheet of a receiving material which is timely fed to the secondary transfer regions.

The receiving material is stocked in a paper cassette 9, and an uppermost sheet is fed to the secondary transfer regions by a pickup roller 10, a pair of registration rollers 11, etc. When the color toner images are secondarily transferred, a positive bias is applied to the secondary transfer roller 6g and thereby the toner images are transferred to the receiving material due to the thus formed transfer electric field.

The lubricant applicator 21 includes a molded lubricant 21b which is contained in a fixed case 7f, a brush roller 21a which scrapes a surface portion of the molded lubricant 21b to apply the scraped lubricant to the surface of the photoreceptor 1 and a pressure spring 21c which presses the molded lubricant to the brush roller 21a. The molded lubricant has a shape of rectangular parallelepiped. The brush roller 21a extends in such a direction so as to be parallel to the axis of the photoreceptor 1. The molded lubricant 21b is pressed by a pressure spring 21c so that the lubricant can be always contacted with the surface of the photoreceptor 1 and almost all the molded lubricant can be used for lubricating the surface of the photoreceptor 1.

The lubricant applicator 21 can be provided in the cleaning device 7. Namely, the cleaning device 7 can include a combination of a cleaning blade 7a and the brush roller 21a which not only applies a lubricant but also catches toner particles remaining on the photoreceptor 1. The toner particles adhered to the brush roller 21a are removed therefrom by the molded lubricant 21b or a flicker. Thus, the toner particles can be collected.

Suitable examples of the materials for use as the lubricant include fatty acid metal salts, silicone oil, fluorine-containing materials (such as resins), etc. These materials can be used alone or in combination. Specific examples of the fatty acid metal salts include zinc stearate, calcium stearate, magnesium stearate, aluminum stearate, iron stearate, etc. Among these materials, zinc stearate is preferably used. In addition, a molded material including a powder of a lubricant such as zinc stearate and calcium stearate and a fluorine-containing resin can also be preferably used.

The cleaning device 7 includes the cleaning blade 7a configured to remove toner particles remaining on the photoreceptor 1, a support 7b configured to support the cleaning blade 7a, a toner collection coil 7c configured to feed the collected toner particles, and a spring 7d configured to press the cleaning blade 7a. Suitable materials for use as the blade 7a include urethane resins. Among the urethane resins, urethane elastomers are preferably used in view of abrasion resistance, ozone resistance and contamination resistance. In this application, urethane rubbers are included in the category of the urethane elastomers.

Then the charging device 3 will be explained in detail. The charging device 3 includes a charging roller 3a which serves as a charging member and which faces the photoreceptor 1, and a charger cleaning member 3b configured to clean the surface of the charging roller 3a and which is contacted with one side of the charging roller 3a opposite to the side contacted with or facing the photoreceptor 1. The charging roller 3a may be contacted with the surface of the photoreceptor 1 or closely set with a small gap therebetween (i.e., a short range charger).

The receiving sheet bearing the color toner images thereon is then fed to a fixing device 8 having a heating roller 8a and a pressure roller 8b to fix the toner images on the receiving sheet. Then the receiving sheet is discharged from the image forming apparatus by a discharge roller 12.

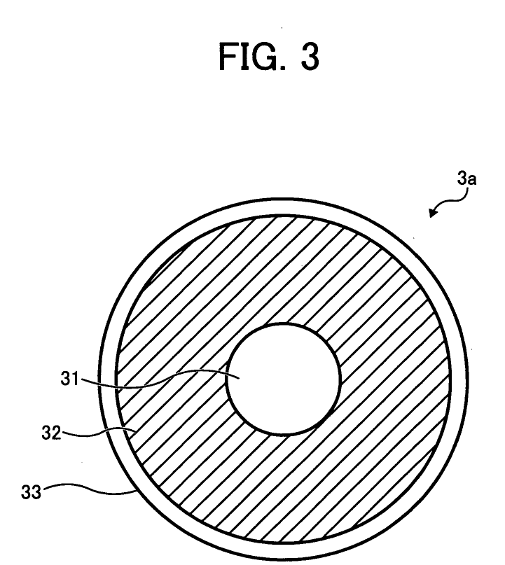

FIG. 3 is a cross section of the charging roller 3a. The charging roller 3a has a metal shaft 31, a resistance controlling layer 32 which is uniformly formed on the metal shaft 31 and a protective layer 33 which is formed on the resistance controlling layer 32 to prevent occurrence of an electric leakage problem.

The charging roller 3a is connected with a power source, from which a predetermined voltage is applied to the charging roller 3a. In this case, a DC voltage overlapped with an AC voltage (hereinafter sometimes referred to as a DC/AC voltage) is applied to uniformly charge the surface of the photoreceptor 1. As mentioned above, when an excessive AC current flows, the filming problem tends to occur. Therefore, it is preferable to control the AC current.

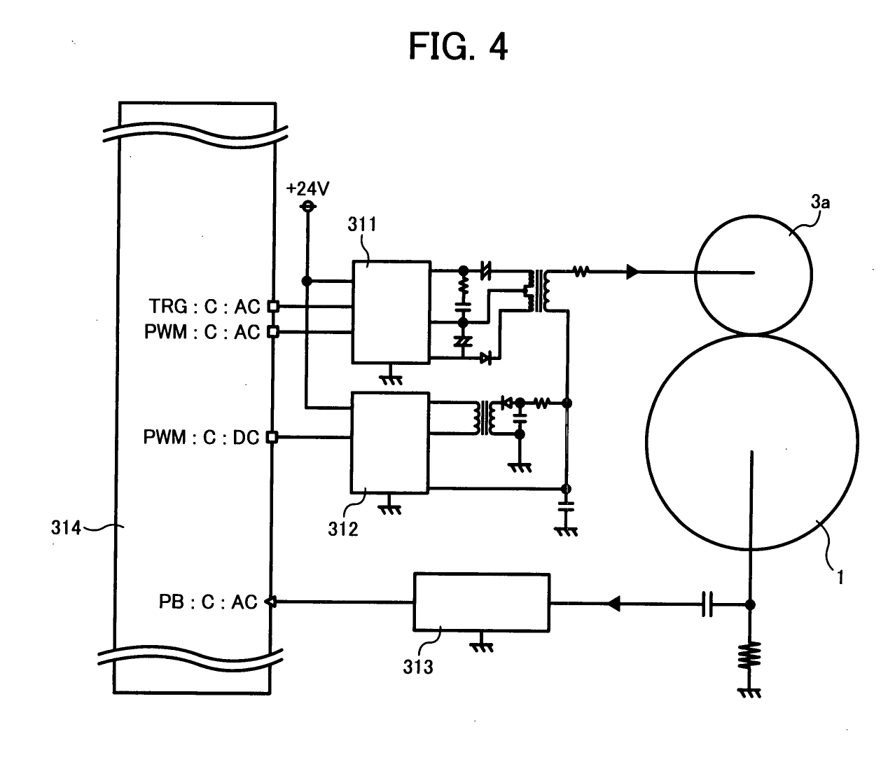

FIG. 4 illustrates a power supplying circuit and an AC current detector. The power supplying circuit supplies a high voltage to one of the four photoreceptors. Therefore, the image forming apparatus has four power supplying circuits. Each power supplying circuit has an AC output circuit 311 and a DC output circuit 312. Since the power supplying circuit has two voltage rising devices, a charge bias can be stably supplied to the charging roller 3a. Although it is possible to use only one voltage rising device, it is preferable to use two voltage rising devices in view of stability of the output voltage.

When a DC/AC voltage is applied to the charging roller, the AC current flows into an AC current return circuit through the charging roller 3a and the photoreceptor 1. An AC current detector 313 which detects only the AC current is provided on a ground (GND) side of the photoreceptor 1. The AC current thus detected is input to a control circuit 314 serving as a controller to determine whether the AC current is within a predetermined range. If the AC current does not fall in the predetermined range, the control circuit 314 controls the AC voltage so as to fall in the predetermined range. Therefore, even when the length of a cable connecting the charging roller 3a with the power supplying circuit is long and thereby a current caused by the stray capacitance of the cable is flown into the photoreceptor 1 from the charging roller 3a, the AC current generated by the applied AC voltage can be controlled so as to fall in the predetermined range.

The present inventors made an experiment in which an AC voltage having a frequency of 1.1 kHz is applied to the charging roller while changing the AC current so as to be from 650 to 750 μA. As a result, when the AC current is from 650 to 690 μA, the filming problem was not caused. When the AC current is from 720 to 750 μA, the filming problem was caused. Thus, by setting an AC current detector between the ground side of the photoreceptor and the control circuit 314 while grounding the AC current detector to check the AC current and properly controlling the AC current, occurrence of the filming problem can be prevented even when a current caused by the stray capacitance of the cable flows and environmental conditions change. In this embodiment, the AC current detector 313 is provided on the board, on which the power supplying circuit of the charging device 3 is provided, in view of maintainability, but the AC current detector can be implemented in the control circuit 314.

When a peak voltage, in which the voltage is controlled so as to be constant, is applied, the AC current changes depending on change of the impedance caused by unevenness in resistance of the charging roller 3a in the rotating direction of the roller, and change of the impedance caused by change of the gap between the surface of the charging roller and the surface of the photoreceptor. When a portion of the charging roller has a high impedance, the AC current has a minimum value. By setting the AC current to a proper current such that the portion of the photoreceptor corresponding to the portion of the charging roller having high impedance has substantially a constant potential (i.e., a potential substantially the same as that of other portions of the photoreceptor), high quality images can be produced without flowing an excessive AC current and without forming abnormal images.

In the above-mentioned method in which the minimum AC current is controlled, there is a possibility that noises such as radiation noises are detected and the noises are determined as the minimum AC current. In order to prevent occurrence of such a problem, it is preferable to neglect currents lower than a predetermined current (i.e., a threshold). In this regard, the smaller the AC current, the lower the surface potential of the photoreceptor, resulting in occurrence of background fouling. Therefore, the threshold is preferably set to an AC current below which the resultant copies have background fouling. In this embodiment, the threshold (Ith) is set to an AC current (specifically, 300 μA) at which the resultant toner image has background fouling, i.e., the background of the image is soiled with toner particles with an area proportion of 1%.

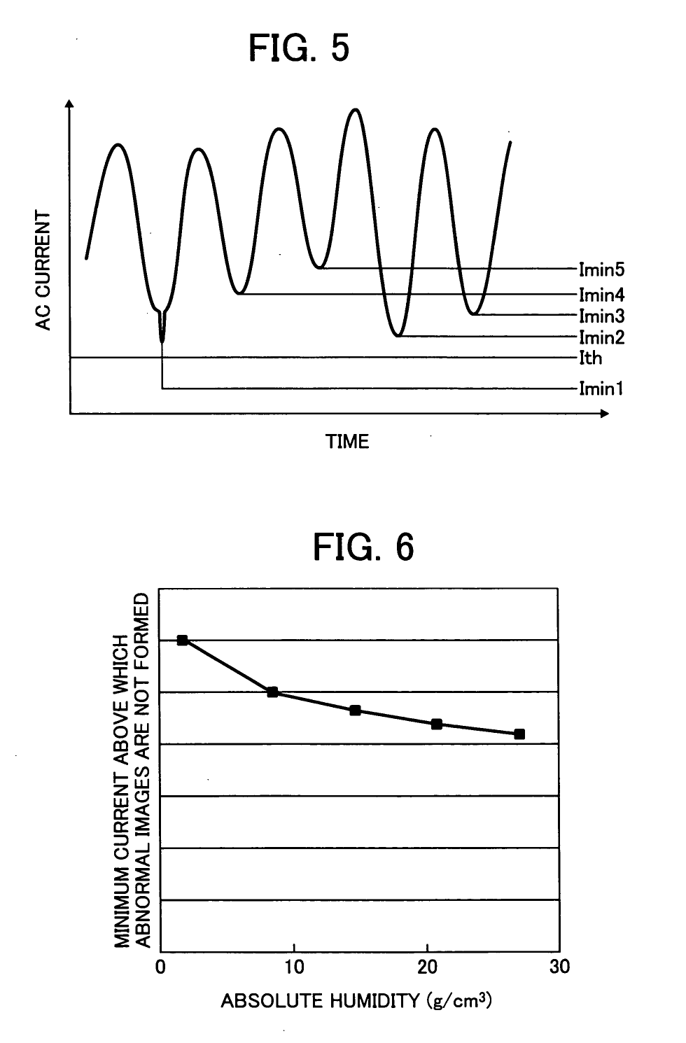

FIG. 5 is a graph illustrating change of AC current with time in the charging roller 3a. As can be understood from FIG. 5, the AC current is periodically changed and the minimum values of the cycles (i.e., Imin1, Imin2, Imin3, Imin4, Imin5, . . . ) are considered to be close to the true minimum value. Therefore, since the Imin1 is minimum in this case, the Imin1 is set to be the Imin. By using this method, it is possible to reduce the AC current without causing abnormal images.

FIG. 6 is a graph illustrating relationship between the minimum AC current and the absolute humidity of air surrounding the charging roller. As can be understood from FIG. 6, the minimum AC current Imin increases as the absolute humidity decreases. Therefore, by changing the Imin depending on the absolute humidity, high quality images without abnormal images can be stably produced for a long period of time without causing the filming problem. If the relationship between the conditions (such as relative humidity) of room air and the absolute humidity of air surrounding the charging roller is known, it is possible to control the Imin depending on the conditions of room air.

Then a case where images are continuously produced and the minimum AC current Imin is changed at the end of the continuous image forming operation, followed by no image forming operations for a long period of time is considered.

When image forming operations are continuously performed, the resistance of the charging roller often changes and the output voltage of the power supplying device temporarily changes. Therefore, the AC voltage applied to the charging roller is changed and thereby the Imin is also changed. In this case, if an image forming operation is not performed thereafter for a long period of time and then an image forming operation is performed, there is a case where abnormal images are caused because the previously set Imin, which is set at the end of the long continuous image forming operation, is different from that in a normal image forming operation. Therefore, it is preferable to change the AC voltage after long period pause such that the Imin is not lower than the Ith. For example, when an image forming operation is not performed for 6 hour or more, the following image forming operation is preferably performed while the AC voltage is changed such that the Imin is not lower than the Ith. By using such a method, occurrence of the filming problem can be prevented for a long period of time.

In addition, it is possible to change the AC voltage such that the Imin is not lower than the Ith after predetermined number of copies (for example, 200 copies in A-4 size) are continuously produced.

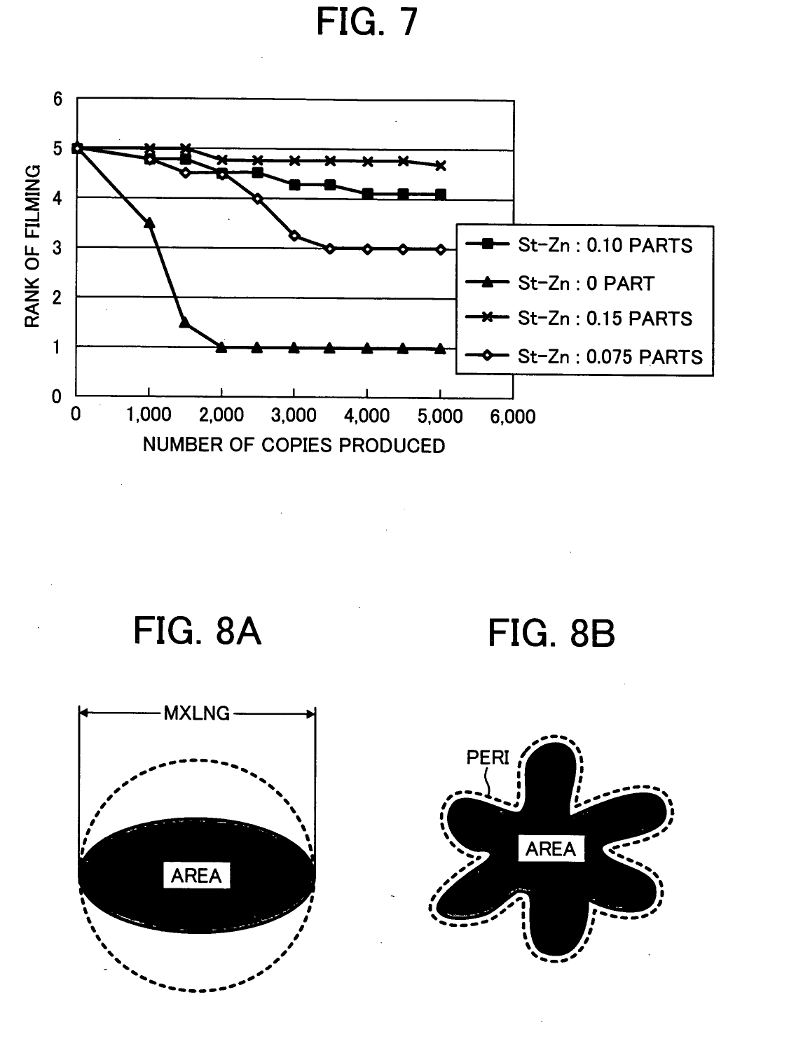

When a toner image including a solid image is formed on the surface of the photoreceptor on which a lubricant is applied with a brush roller, the weight of the lubricant present on a portion of the photoreceptor corresponding to a solid image is decreased, and thereby the filming problem tends to be easily caused. In order to prevent occurrence of such a filming problem, it is preferable to include a lubricant (such as zinc stearate) in the toner used for development. In this case, the lubricant present on the surface of toner particles is applied on the surface of the photoreceptor when the toner particles are scraped by the cleaning blade. FIG. 7 is a graph illustrating the effect of a lubricant (zinc stearate) on the film formation on a photoreceptor. It is clear from FIG. 7 that when zinc stearate is included in the toner in an amount of 0.15 parts per 100 parts of the toner, occurrence of the filming problem can be prevented even when 5000 copies are produced.

A process cartridge which includes at least the charging device 3 mentioned above and the photoreceptor 1 and which is set in an image forming apparatus as a unit can be used for the image forming apparatus. The process cartridge can include other devices such as the developing device 5, cleaning device 7 and lubricant applicator 21 mentioned above. The process cartridge has such a configuration as illustrated in FIG. 2. By using such a process cartridge, the length of a cable connecting the charging roller 3a and the power supplying circuit of the charging device and a cable connecting the photoreceptor and the AC current detector can be controlled, and thereby variation of the stray capacitance of the cables can be minimized. Therefore, the control range of the AC voltage applied to the charging roller can be narrowed.

In addition, by using such a process cartridge, the maintainability of the image forming apparatus can be improved. For example, if the photoreceptor 1, charging device 3, developing device 5, cleaning device 7, and/or a lubricant applicator 21 are damaged, the image forming apparatus can be restored quickly by replacing the process cartridge including the damaged device with a new process cartridge. Namely, the down time can be shortened. In addition, by improving the cleanability of the photoreceptor 5, the life of the process cartridge can be prolonged.

The image forming apparatus of the present invention preferably uses a spherical toner having the following properties.

The toner for use in the present invention preferably has a volume average particle diameter (Dv) of from 3 to 8 μm, and a ratio (Dv/Dn) (i.e., a ratio of the volume average particle diameter (Dv) to the number average particle diameter (Dn)) of from 1.10 to 1.40.

When a spherical toner having such a small particle diameter is used, the toner can be faithfully adhered to an electrostatic latent image, resulting in formation of a high quality image.

When such a toner is used for a two component developer, the toner tends to cause a problem in that the developer is adhered and fixed to the carrier used, resulting in deterioration of the charging ability of the carrier. When the toner is used as a one component developer, the toner tends to form a film on developing members such as a developing roller and a developer layer forming blade.

In contrast, when the volume average particle diameter of the toner is too large, high resolution images cannot be produced and in addition a problem in that the particle diameter distribution of the toner largely changes when the toner is used while replenishing a fresh toner occurs.

When the particle diameter distribution is sharp (i.e., the ration (Dv/Dn) approaches 1.00), the distribution of charges of toner particles becomes sharp, and thereby high quality images with little background fouling can be produced. In addition, the resultant toner has good transferability. When the ratio (Dv/Dn) is too large, the toner has a broad charge quantity distribution and the resultant images have poor resolution.

The volume average particle diameter (Dv), number average particle diameter (Dn) and particle diameter distribution of a toner can be measured using an instrument COULTER COUNTER TAII or MULTISIZER II from Coulter Electronics Inc., an interface by which particle diameter distributions on number basis and volume basis can be output and which is manufactured by Nikkaki Bios Co., Ltd., and a personal computer PC9801 manufactured by NEC Corp. In addition, the ratio Dv/Dn was determined on calculation.

The toner for use in image forming apparatus of the present invention preferably has a shape factor SF-1 of from 100 to 180 and another shape factor SF-2 of from 100 to 180.

FIGS. 7A and 7B are schematic views for explaining the shape factors SF-1 and SF-2, respectively.

As illustrated in FIG. 8A, the shape factor SF-1 represents the degree of the roundness of a toner and is defined by the following equation (1):
SF-1={(MXLNG)²/(AREA)}×(100π/4) (1)
wherein MXLNG represents a diameter of the circle circumscribing the image of a toner particle, which image is obtained by observing the toner particle with a microscope; and AREA represents the area of the image.

When the SF-1 is 100, the toner particle has a true spherical form. In this case, the toner particles contact the other toner particles and the photoreceptor serving as an image bearing member at one point. Therefore, the adhesion of the toner particles to the other toner particles and the photoreceptor decreases, resulting in increase of the fluidity of the toner particles and the transferability of the toner. When the SF-1 is too large, the toner particles have irregular forms and thereby the toner has poor developability and poor transferability.

As illustrated in FIG. 8B, the shape factor SF-2 represents the degree of the concavity and convexity of a toner particle, and is defined by the following equation (2):
SF-2={(PERI)²/(AREA)}×(100/4π) (2)
wherein PERI represents the peripheral length of the image of a toner particle observed by a microscope; and AREA represents the area of the image.

When the SF-2 approaches 100, the toner particles have a smooth surface (i.e., the toner has few concavity and convexity) It is preferable for a toner to have a slightly roughened surface because the toner has good cleanability. However, when the SF-2 is too large (i.e., the toner particles are seriously roughened), a toner scattering problem in that toner particles are scattered around a toner image is caused, resulting in deterioration of the toner image qualities.

The shape factors SF-1 and SF-2 are determined by the following method:
(1) particles of a toner are photographed using a scanning electron microscope (S-800, manufactured by Hitachi Ltd.); and
(2) photograph images of 100 toner particles are analyzed using an image analyzer (LUZEX 3 manufactured by Nireco Corp.) to determine the SF-1 and SF-2.

The toner for use in the image forming apparatus of the present invention is preferably a toner which is prepared by preparing a toner composition liquid in which a toner composition including at least a polyester prepolymer having a functional group including a nitrogen atom, a polyester resin, a colorant and a release agent are dissolved or dispersed in an organic solvent, and dispersing the toner composition liquid in an aqueous medium to crosslink and/or extend (i.e., grow the molecular chain) the polyester prepolymer.

Then the toner constituents and the method for manufacturing the toner will be explained in detail.

(Modified Polyester)

The toner for use in the image forming apparatus of the present invention preferably includes a modified polyester resin (i). In this application, the modified polyester resin is defined as a polyester resin which has a bond other than the ester bond or which includes therein another resin component which is bonded with the polyester resin component by a covalent bond, ionic bond or other bond. Specifically, the modified polyester resin is defined as a modified polyester resin prepared by incorporating a group such as an isocyanate group, which is reactive with a carboxyl group, and a hydroxyl group, at an end portion thereof, and then reacting the group with a compound having an active hydrogen atom.

Suitable modified polyester resins for use in the toner in the present invention include urea-modified polyester resins which are prepared by reacting a polyester prepolymer (A) having an isocyanate group with an amine (B). Polyester prepolymers (A) can be prepared by a polycondensation product of a polyol (PO) and a polycarboxylic acid (PC) (i.e., a polyester resin having a group including an active hydrogen atom) with a polyisocyanate (PIC). Specific examples of the group including an active hydrogen atom include hydroxyl groups (alcoholic hydroxyl group and phenolic hydroxyl group), amino groups, carboxyl groups, mercapto groups, etc. Among these groups, the alcoholic hydroxyl group is preferable.

Suitable polyols (PO) for use in preparing the modified polyester resin include diols (DIO), polyols (TO) having three or more hydroxyl groups, and mixtures of DIO and TO. Preferably, diols (DIO) alone or mixtures of a diol (DIO) and a small amount of polyol (TO) are used.

Specific examples of the diols (DIO) include alkylene glycols, alkylene ether glycols, alicyclic diols, bisphenols, alkylene oxide adducts of alicyclic diols, alkylene oxide adducts of bisphenols, etc.

Specific examples of the alkylene glycols include ethylene glycol, 1,2-propylene glycol, 1,3-propylene glycol, 1,4-butanediol and 1,6-hexanediol. Specific examples of the alkylene ether glycols include diethylene glycol, triethylene glycol, dipropylene glycol, polyethylene glycol, polypropylene glycol and polytetramethylene ether glycol. Specific examples of the alicyclic diols include 1,4-cyclohexane dimethanol and hydrogenated bisphenol A. Specific examples of the bisphenols include bisphenol A, bisphenol F and bisphenol S. Specific examples of the alkylene oxide adducts of alicyclic diols include adducts of the alicyclic diols mentioned above with an alkylene oxide (e.g., ethylene oxide, propylene oxide and butylene oxide). Specific examples of the alkylene oxide adducts of bisphenols include adducts of the bisphenols mentioned above with an alkylene oxide (e.g., ethylene oxide, propylene oxide and butylene oxide).

Among these compounds, alkylene glycols having from 2 to 12 carbon atoms and alkylene oxide adducts of bisphenols are preferable. More preferably, alkylene oxide adducts of bisphenols, and mixtures of an alkylene oxide adduct of a bisphenol and an alkylene glycol having from 2 to 12 carbon atoms are used.

Specific examples of the polyols (TO) include aliphatic alcohols having three or more hydroxyl groups (e.g., glycerin, trimethylol ethane, trimethylol propane, pentaerythritol and sorbitol); polyphenols having three or more hydroxyl groups (trisphenol PA, phenol novolak and cresol novolak); adducts of the polyphenols mentioned above with an alkylene oxide such as ethylene oxide, propylene oxide and butylene oxide; etc.

Suitable polycarboxylic acids (PC) for use in preparing the modified polyester resin include dicarboxylic acids (DIC) and polycarboxylic acids (TC) having three or more carboxyl groups. Preferably, dicarboxylic acids (DIC) alone and mixtures of a dicarboxylic acid (DIC) with a small amount of polycarboxylic acid (TC) are used.

Specific examples of the dicarboxylic acids (DIC) include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acids (TC) having three or more hydroxyl groups include aromatic polycarboxylic acids having from 9 to 20 carbon atoms (e.g., trimellitic acid and pyromellitic acid).

When a polycarboxylic acid (PC) is reacted with a polyol (1), anhydrides or lower alkyl esters (e.g.,methyl esters, ethyl esters or isopropyl esters) of the polycarboxylic acids mentioned above can also be used as the polycarboxylic acid (PC).

Suitable mixing ratio (i.e., the equivalence ratio [OH]/[COOH]) of the [OH] group of a polyol (PO) to the [COOH] group of a polycarboxylic acid (PC) is from 2/1 to 1/1, preferably from 1.5/1 to 1/1 and more preferably from 1.3/1 to 1.02/1.

Specific examples of the polyisocyanates (PIC) for use in preparing the modified polyester resin include aliphatic polyisocyanates (e.g., tetramethylene diisocyanate, hexamethylene diisocyanate and 2,6-diisocyanate methylcaproate); alicyclic polyisocyanates (e.g., isophorone diisocyanate and cyclohexylmethane diisocyanate); aromatic diisocianates (e.g., tolylene diisocyanate and diphenylmethane diisocyanate); aromatic aliphatic diisocyanates (e.g., a, a, α′,α′-tetramethyl xylylene diisocyanate); isocyanurates; blocked polyisocyanates in which the polyisocyanates mentioned above are blocked with phenol derivatives, oximes or caprolactams; etc. These compounds can be used alone or in combination.

Suitable mixing ratio (i.e., the equivalence ratio [NCO]/[OH]) of the [NCO] group of a polyisocyanate (PIC) to the [OH] group of a polyester is from 5/1 to 1/1, preferably from 4/1 to 1.2/1 and more preferably from 2.5/1 to 1.5/1. When the [NCO]/[OH] ratio is too large, the low temperature fixability of the toner deteriorates. In contrast, when the ratio is too small, the content of the urea group in the modified polyesters decreases, thereby deteriorating the hot-offset resistance of the toner.

The content of the polyisocyanate unit in the polyester prepolymer (A) having an isocyanate group is from 0.5 to 40% by weight, preferably from 1 to 30% by weight and more preferably from 2 to 20% by weight. When the content is too low, the hot offset resistance of the toner deteriorates and in addition a good combination of preservability and low temperature fixability cannot be imparted to the resultant toner. In contrast, when the content is too high, the low temperature fixability of the toner deteriorates.

The average number of the isocyanate group included in a molecule of the polyester prepolymer (A) is generally not less than 1, preferably from 1.5 to 3, and more preferably from 1.8 to 2.5. When the average number of the isocyanate group is too small, the molecular weight of the resultant urea-modified polyester (which is crosslinked and/or extended) decreases, thereby deteriorating the hot offset resistance of the resultant toner.

The urea-modified polyester resin for use as a binder resin of the toner of the present invention can be prepared by reacting a polyester prepolymer (A) having an isocyanate group with an amine (B).

Specific examples of the amines (B) include diamines (B1), polyamines (B2) having three or more amino groups, amino alcohols (B3), amino mercaptans (B4), amino acids (B5) and blocked amines (B6) in which the amines (B1-B5) mentioned above are blocked. These amines can be used alone or in combination.

Specific examples of the diamines (B1) include aromatic diamines (e.g., phenylene diamine, diethyltoluene diamine and 4,4′-diaminodiphenyl methane); alicyclic diamines (e.g., 4,4′-diamino-3,3′-dimethyldicyclohexyl methane, diaminocyclohexane and isophoron diamine); aliphatic diamines (e.g., ethylene diamine, tetramethylene diamine and hexamethylene diamine); etc.

Specific examples of the polyamines (B2) having three or more amino groups include diethylene triamine, triethylene tetramine, etc. Specific examples of the amino alcohols (B3) include ethanol amine, hydroxyethyl aniline, etc. Specific examples of the amino mercaptan (B4) include aminoethyl mercaptan, aminopropyl mercaptan, etc. Specific examples of the amino acids (B5) include amino propionic acid, amino caproic acid, etc. Specific examples of the blocked amines (B6) include ketimine compounds which are prepared by reacting one of the amines (B1-B5) mentioned above with a ketone such as acetone, methyl ethyl ketone and methyl isobutyl ketone; oxazoline compounds, etc. Among these amines, diamines (B1) and mixtures of a diamine (B1) with a small amount of a polyamine (B2) are preferably used.

The molecular weight of the urea-modified polyesters can be controlled using a molecular chain extension inhibitor, if desired. Specific examples of the molecular chain extension inhibitor include monoamines (e.g., diethylamine, dibutylamine, butyl amine and lauryl amine), and blocked amines (i.e., ketimine compounds) prepared by blocking the monoamines mentioned above.

The mixing ratio (i.e., the equivalence ratio [NCO]/[NHx]) of the [NCO] group of the prepolymer (A) having an isocyanate group to the [NHx] group of the amine (B) is from 1/2 to 2/1, preferably from 1/1.5 to 1.5/1 and more preferably from 1/1.2 to 1.2/1. When the mixing ratio is too low or too high, the molecular weight of the resultant urea-modified polyester decreases, resulting in deterioration of the hot offset resistance of the resultant toner.

The urea-modified polyester resins for use in the toner can include a urethane bonding as well as a urea bonding. The molar ratio of the urea bonding to the urethane bonding is from 100/0 to 10/90, preferably from 80/20 to 20/80, and more preferably from 60/40 to 30/70. When the molar ratio of the urea bonding is too low, the hot offset resistance of the resultant toner deteriorates.

The modified polyesters (i) can be prepared, for example, by a method such as one-shot methods or prepolymer methods. The weight average molecular weight of the modified polyesters (i) is generally not less than 10,000, preferably from 20,000 to 10,000,000 and more preferably from 30,000 to 1,000,000. When the weight average molecular weight is too low, the polyester resins are hardly subjected to a molecular chain extension reaction, and thereby the resultant toner has poor elasticity. As a result, the hot offset resistance of the resultant toner deteriorates. In contrast, when the molecular weight is too high, the fixability of the toner deteriorates. In addition, the productivity of the toner deteriorates, specifically, the efficiency in a granulation process or a pulverization process deteriorates.

The number average molecular weight of the modified polyester resin (i) is not particularly limited if an unmodified polyester resin (ii) is used in combination therewith. Specifically, the weight average molecular weight of the modified polyester resin is mainly controlled rather than the number average molecular weight. When the modified polyester resin is used alone, the number average molecular weight of the resin is preferably not greater than 20,000, preferably from 1,000 to 10,000, and more preferably from 2,000 to 8,000. When the number average molecular weight is too high, the low temperature fixability of the resultant toner deteriorates. In addition, when the toner is used as a color toner, the resultant toner has low glossiness.

The modified polyester resin (i) is prepared by subjecting a polyester prepolymer (A) to a crosslinking reaction and/or a molecular chain extension reaction using an amine (B). In this case, a reaction inhibitor can be used to control the molecular weight of the resultant modified polyester resin. Suitable materials for use as the reaction inhibitor include monoamines such as diethyl amine, dibutyl amine, butyl amine and lauryl amine, and blocked amines of the monoamines such as ketimine compounds.

The molecular weight of the polymer thus prepared is determined by gel permeation chromatograph using tetrahydrofuran as the solvent.

(Unmodified Polyester)

In the present invention, it is preferable to use a combination of a modified polyester resin (i) with an unmodified polyester resin (ii) as the binder resin of the toner. By using such a combination, the low temperature fixability of the toner can be improved and in addition the toner can produce color images having a high glossiness.

Suitable materials for use as the unmodified polyester resin (ii) include polycondensation products of a polyol (PO) with a polycarboxylic acid (PC). Specific examples of the polyol (PO) and polycarboxylic acid (PC) are mentioned above for use in the modified polyester resin (i). In addition, specific examples of the suitable polyol and polycarboxylic acid are also mentioned above.

In addition, polyester resins modified by a bonding (such as urethane bonding) other than a urea bonding are considered as the unmodified polyester resin (ii) in the present application.

When a combination of a modified polyester resin (i) with an unmodified polyester resin (ii) is used as the binder resin, it is preferable that the modified polyester resin is at least partially mixed with the unmodified polyester resin to improve the low temperature fixability and hot offset resistance of the toner. Namely, it is preferable that the modified polyester resin has a molecular structure similar to that of the unmodified polyester resin. The mixing ratio (i/ii) of a modified polyester resin (i) to an unmodified polyester resin (ii) is from 5/95 to 60/40, preferably from 5/95 to 30/70, more preferably from 5/95 to 25/75, and even more preferably from 7/93 to 20/80. When the added amount of the modified polyester resin is too small, the hot offset resistance of the toner deteriorates and in addition, it is impossible to achieve a good combination of high temperature preservability and low temperature fixability.

The peak molecular weight of the unmodified polyester resin (ii) is from 1,000 to 10,000, preferably from 2,000 to 8,000 and more preferably from 2,000 to 5,000. When the peak molecular weight is too low, the high temperature preservability of the toner deteriorates. In contrast, when the peak molecular weight is too high, the low temperature fixability of the toner deteriorates.

The unmodified polyester resin (ii) preferably has a hydroxyl value not less than 5 mgKOH/g, and more preferably from 10 to 120 mgKOH/g, and even more preferably from 20 to 80 mgKOH/g. When the hydroxyl value is too small, the resultant toner has poor high temperature preservability and poor low temperature fixability.

The unmodified polyester resin (i) preferably has an acid value of from 1 to 5 mgKOH/g, and more preferably from 2 to 4 mgKOH/g. When a wax having a high acid value is used as a release agent while a resin having a relatively low acid value is used as a binder resin, good charge properties and high volume resistivity can be imparted to the toner. The thus prepared toner can be preferably used for two component developers.

The binder resin for use in the toner preferably has a glass transition temperature (Tg) of from 35 to 70° C. and more preferably from 55 to 65° C. When the glass transition temperature is too low, the high temperature preservability of the toner deteriorates. In contrast, when the glass transition temperature is too high, the low temperature fixability deteriorates. When the toner of the present invention includes a urea-modified polyester resin and an unmodified polyester resin, the toner has relatively good preservability compared to conventional toners including a polyester resin as a binder resin even when the glass transition temperature of the toner of the present invention is lower than the polyester resin included in the conventional toners. This is because the urea-modified polyester resin is typically present on a surface of toner particles.

The glass transition temperature of a resin can be determined by a method using a differential scanning calorimeter (DSC).

Colorant

The toner for use in the image forming apparatus of the present invention includes a colorant. Suitable materials for use as the colorant include known dyes and pigments.

Specific examples of the dyes and pigments include carbon black, Nigrosine dyes, black iron oxide, NAPHTHOL YELLOWS, HANSA YELLOW 10G, HANSA YELLOW 5G, HANSA YELLOW G, Cadmium Yellow, yellow iron oxide, loess, chrome yellow, Titan Yellow, polyazo yellow, Oil Yellow, HANSA YELLOW GR, HANSA YELLOW A, HANSA YELLOW RN, HANSA YELLOW R, PIGMENT YELLOW L, BENZIDINE YELLOW G, BENZIDINE YELLOW GR, PERMANENT YELLOW NCG, VULCAN FAST YELLOW 5G, VULCAN FAST YELLOW R, Tartrazine Lake, Quinoline Yellow LAKE, ANTHRAZANE YELLOW BGL, isoindolinone yellow, red iron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED F2R, PERMANENT RED F4R, PERMANENT RED FRL, PERMANENT RED FRLL, PERMANENT RED F4RH, Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE RS, INDANTHRENE BLUE BC, Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and the like. These materials are used alone or in combination.

The content of the colorant in the toner is preferably from 1 to 15% by weight, and more preferably from 3 to 10% by weight of the toner.

Master batches, which are complexes of a colorant with a resin, can be used as the colorant of the toner for use in the present invention.

Specific examples of the resins for use as the binder resin of the master batches include polymers of styrene or styrene derivatives, copolymers of styrene with a vinyl monomer, polymethyl methacrylate, polybutyl methacrylate, polyvinyl chloride, polyvinyl acetate, polyethylene, polypropylene, polyesters, epoxy resins, epoxy polyol resins, polyurethane resins, polyamide resins, polyvinyl butyral resins, acrylic resins, rosin, modified rosins, terpene resins, aliphatic or alicyclic hydrocarbon resins, aromatic petroleum resins, chlorinated paraffin, paraffin waxes, etc. These can be used alone or in combination.

Charge Controlling Agent

The toner for use in the image forming apparatus of the present invention preferably includes a charge controlling agent. Any known charge controlling agents can be used for the toner.

Suitable examples of the charge controlling agents include Nigrosine dyes, triphenyl methane dyes, chromium-containing metal complex dyes, molybdic acid chelate pigments, Rhodamine dyes, alkoxyamines, quaternary ammonium salts, fluorine-modified quaternary ammonium salts, alkylamides, phosphor and its compounds, tungsten and its compounds, fluorine-containing activators, metal salts of salicylic acid, metal salts of salicylic acid derivatives, etc. Among these materials, metal salts of salicylic acid and salicylic acid derivatives are preferably used. These materials can be used alone or in combination.

Specific examples of the marketed charge controlling agents include BONTRON® 03 (Nigrosine dye), BONTRON® P-51 (quaternary ammonium salt), BONTRON®-34 (metal-containing azo dye), BONTRON® E-82 (metal complex of oxynaphthoic acid), BONTRON® E-84 (metal complex of salicylic acid), and BONTRON® E-89 (phenolic condensation product), which are manufactured by Orient Chemical Industries Co., Ltd.; TP-302 and TP-415 (molybdenum complex of quaternary ammonium salt), which are manufactured by Hodogaya Chemical Co., Ltd.; COPY CHARGE® PSY VP2038 (quaternary ammonium salt), COPY BLUE® (triphenyl methane derivative), COPY CHARGE® NEG VP2036 and COPY CHARGE® NX VP434 (quaternary ammonium salt), which are manufactured by Hoechst AG; LRA-901, and LR-147 (boron complex), which are manufactured by Japan Carlit Co., Ltd.; copper phthalocyanine, perylene, quinacridone, azo pigments, and polymers having a functional group such as a sulfonate group, a carboxyl group, a quaternary ammonium group, etc.

The content of the charge controlling agent in the toner of the present invention is determined depending on the variables such as choice of binder resin; presence of additives, and dispersion method. In general, the content of the charge controlling agent is preferably from 0.1 to 10 parts by weight, and more preferably from 0.2 to 5 parts by weight, per 100 parts by weight of the binder resin included in the toner. When the content is too high, the charge quantity of the toner excessively increases, and thereby the electrostatic attraction between the developing roller and the toner increases, resulting in deterioration of fluidity and decrease of image density.

Release Agent

The toner for use in the image forming apparatus of the present invention can include a release agent. Suitable release agents include waxes having a melting point of from 50 to 120° C. When such a wax is included in the toner, the wax is dispersed in the binder resin and serves as a release agent while being present at a location between a fixing roller and the toner particles in the fixing process. Thereby the hot offset problem can be avoided without applying an oil to the fixing roller used.

Specific examples of the release agent include natural waxes such as vegetable waxes, e.g., carnauba wax, cotton wax, Japan wax and rice wax; animal waxes, e.g., bees wax and lanolin; mineral waxes, e.g., ozokelite and ceresine; and petroleum waxes, e.g., paraffin waxes, microcrystalline waxes and petrolatum. In addition, synthesized waxes can also be used. Specific examples of the synthesized waxes include synthesized hydrocarbon waxes such as Fischer-Tropsch waxes and polyethylene waxes; and synthesized waxes such as ester waxes, ketone waxes and ether waxes. Further, fatty acid amides such as 1,2-hydroxylstearic acid amide, stearic acid amide and phthalic anhydride imide; and low molecular weight crystalline polymers such as acrylic homopolymer and copolymers having a long alkyl group in their side chain, e.g., poly-n-stearyl methacrylate, poly-n-laurylmethacrylate and n-stearyl acrylate-ethyl methacrylate copolymers, can also be used.

The above-mentioned charge controlling agent and release agent can be kneaded with a master batch and a binder resin. Alternatively, the charge controlling agent and the release agent can be added to an organic solvent when the toner composition liquid is prepared.

External Additive

A particulate inorganic material is typically mixed with toner particles to assist in improving the fluidity, developing property and charging ability of the toner particles. It is preferable for the particulate inorganic materials to have a primary particle diameter of from 5 nm to 2 μm, and more preferably from 5 nm to 500 nm. In addition, it is preferable that the specific surface area of such particulate inorganic-materials measured by a BET method is from 20 to 500 m²/g. The content of the external additive is preferably from 0.01 to 5% by weight, and more preferably from 0.01 to 2.0% by weight, based on total weight of the toner composition.

Specific examples of such particulate inorganic materials include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

Among these particulate inorganic materials, a combination of a hydrophobic silica and a hydrophobic titanium oxide is preferably used. In particular, when a combination of a hydrophobic silica with a hydrophobic titanium oxide each having an average particle diameter not greater than 50 nm is used as an external additive, the electrostatic force and van der Waals' force between the external additive and the toner particles can be improved, and thereby the resultant toner has a proper charge quantity. In addition, even when the toner is agitated in a developing device, the external additive is hardly released from the toner particles, and thereby image defects such as white spots and image omissions are hardly produced. Further, the quantity of particles of the toner remaining on image bearing members can be reduced.

Titanium oxide exhibits high stability to withstand environmental conditions, and stably produce high density images. However, titanium oxide has a drawback in that the charge rising property of the toner deteriorates. Therefore it is not preferable that the content of titanium oxide is higher than that of silica. When the content of a hydrophobized titanium oxide is from 0.3 to 1.5% by weight, the charge rising property of the resultant toner hardly deteriorates. Therefore, images having good image qualities can be stably produced even when images are repeatedly produced.

Then the method for preparing the toner for use in the present invention will be explained.

(1) Preparation of Toner Composition Liquid

At first, a toner composition liquid is prepared by dissolving or dispersing toner constituents such as a colorant, an unmodified polyester resin, a prepolymer having an isocyanate group and a release agent in an organic solvent. The organic solvent is preferably a volatile solvent having a boiling point less than 100° C. so as to be easily removed from the resultant toner particles. Specific examples of such volatile solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, and methyl isobutyl ketone. These solvents can be used alone or in combination. In particular, aromatic solvents such as toluene and xylene, and halogenated hydrocarbons such as methylene chloride, 1,2-dichloroethane, chloroform and carbon tetrachloride are preferably used.

The weight ratio of the solvent to the polyester prepolymer is generally from 0/100 to 300/100, preferably from 0/100 to 100/100 and more preferably from 25/100 to 70/100.

(2) Emulsification of the Toner Composition Liquid

The toner composition liquid is then dispersed in an aqueous medium in the presence of a surfactant and a particulate resin to prepare an emulsion. Suitable materials for use as the aqueous medium include water. In addition, organic solvents which can be mixed with water can be added to water. Specific examples of such solvents include alcohols such as methanol, isopropanol, and ethylene glycol; dimethylformamide, tetrahydrofuran, cellosolves such as methyl cellosolve, lower ketones such as acetone and methyl ethyl ketone, etc.

The weight ratio of the aqueous medium to the toner composition liquid is generally from 50/100 to 2,000/100 and preferably from 100/100 to 1,000/100. When the added amount of the aqueous medium is too low, the toner composition liquid cannot be well dispersed, and thereby toner particles having a desired particle diameter cannot be prepared. Adding a large amount of aqueous medium is not economical.

When the toner composition liquid is emulsified, a dispersant such as surfactants and particulate resins are preferably included in the aqueous medium.

Specific examples of the surfactants include anionic surfactants such as alkylbenzene sulfonic acid salts, α-olefin sulfonic acid salts, and phosphoric acid salts; cationic surfactants such as amine salts (e.g., alkyl amine salts, aminoalcohol fatty acid derivatives, polyamine fatty acid derivatives and imidazoline), and quaternary ammonium salts (e.g., alkyltrimethyl ammonium salts, dialkyldimethyl ammonium salts, alkyldimethyl benzyl ammonium salts, pyridinium salts, alkyl isoquinolinium salts and benzethonium chloride); nonionic surfactants such as fatty acid amide derivatives, polyhydric alcohol derivatives; and ampholytic surfactants such as alanine, dodecyldi(aminoethyl)glycin, di)octyl aminoethyle)glycin, and N-alkyl-N,N-dimethylammonium betaine.

By using a fluorine-containing surfactant as the surfactant, good effects can be produced even when the added amount is small.

Specific examples of anionic surfactants having a fluoroalkyl group include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4) sulfonate, sodium 3-{omega-fluoroalkanoyl(C6-C8)-N-ethylamino}-1-propanesulfonate, fluoroalkyl(C11-C20) carboxylic acids and their metal salts, perfluoroalkyl (C7-C13) carboxylic acids and their metal salts, perfluoroalkyl (C4-C12) sulfonate and their metal salts, perfluorooctanesulfonic acid diethanol amides, N-propyl-N-(2-hydroxyethyl)perfluorooctanesulfone amide, perfluoroalkyl(C6-C10) sulfoneamidepropyltrimethylammonium salts, salts of perfluoroalkyl (C6-C10)-N-ethylsulfonyl glycin, monoperfluoroalkyl(C6-C16) ethylphosphates, etc.

Specific examples of the marketed products of such surfactants include SARFRON® S-111, S-112 and S-113, which are manufactured by Asahi Glass Co., Ltd.; FLUORAD® FC-93, FC-95, FC-98 and FC-129, which are manufactured by Sumitomo 3M Ltd.; UNIDYNE® DS-101 and DS-102, which are manufactured by Daikin Industries, Ltd.; MEGAFACE® F-110, F-120, F-113, F-191, F-812 and F-833 which are manufactured by Dainippon Ink and Chemicals, Inc.; ECTOP® EF-102, 103, 104, 105, 112, 123A, 306A, 501, 201 and 204, which are manufactured by Tohchem Products Co., Ltd.; FUTARGENT® F-100 and F150 manufactured by Neos; etc.

Specific examples of the cationic surfactants having a fluoroalkyl group, which can disperse an oil phase including toner constituents in water, include primary, secondary and tertiary aliphatic amines having a fluoroalkyl group, aliphatic quaternary ammonium salts such as perfluoroalkyl (C6-C10) sulfoneamidepropyltrimethylammonium salts, benzalkonium salts, benzetonium chloride, pyridinium salts, imidazolinium salts, etc. Specific examples of the marketed products thereof include SARFRON® S-121 (from Asahi Glass Co., Ltd.); FLUORAD® FC-135 (from Sumitomo 3M Ltd.); UNIDYNE® DS-202 (from Daikin Industries, Ltd.); MEGAFACE® F-150 and F-824 (from Dainippon Ink and Chemicals, Inc.); ECTOP®EF-132 (from Tohchem Products Co., Ltd.); FUTARGENT® F-300 (from Neos); etc.

Particulate resins are added to the aqueous medium to stabilize the toner particles which are prepared in the aqueous medium. Any known resins which can form an aqueous dispersion can be used as the particulate resin. Specific examples of the resins include thermoplastic resins and thermosetting resins such as vinyl resins, polyurethane resins, epoxy resins, polyester resins, polyamide resins, polyimide resins, silicone resins, phenolic resins, melamine resins, urea resins, aniline resins, ionomer resins, polycarbonate resins, etc. These resins can be used alone or in combination.

Among these resins, vinyl resins, polyurethane resins, epoxy resins, polyester resins and combinations thereof are preferably used because a resin dispersion including fine resin particles can be easily obtained. Suitable vinyl resins for use as the particulate resin include homopolymers and copolymers of vinyl monomers. Specific examples of the vinyl resins include styrene—(meth)acrylate copolymers, styrene—butadiene copolymers, (meth)acrylic acid—arylate copolymers, styrene—acrylonitrile copolymers, styrene—maleic anhydride copolymers, styrene—(meth)acrylic acid copolymers, etc. The average particle diameter of the particulate resins is preferably from 5 to 200 nm, and more preferably from 20 to 300 nm.

In addition, inorganic compounds can be used as a dispersant. Specific examples of the inorganic compounds include tricalcium phosphate, calcium carbonate, titanium oxide, colloidal silica, and hydroxyapatite can be preferably used.

Further, it is preferable to stabilize the emulsion or dispersion using a polymer protection colloid in combination with the particulate resins and inorganic dispersants.

Specific examples of such protection colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine).

In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

Known dispersing machines can be used for emulsifying the toner composition liquid in an aqueous medium. Suitable dispersing machines include low speed shearing dispersion machines, high speed shearing dispersion machines, friction dispersion machines, high pressure jet dispersion machines, ultrasonic dispersion machines, etc.

When high speed shearing dispersion machines are used, the rotation number of the rotor is not particularly limited, but the rotation number is generally from 1,000 to 30,000 rpm, and preferably from 5,000 to 20,000. The dispersion time is not particularly limited. When a batch dispersion machines are used, the dispersion time is generally from 0.1 to 5 minutes.

The dispersion temperature is preferably from 0 to 150° C. and preferably from 40 to 98° C.

(3) Reaction of Polyester Prepolymer (A) with Amine (B)

When the toner composition liquid is added in an aqueous medium to prepare an emulsion, an amine is added to the mixture to react the amine with the polyester prepolymer having an isocyanate group. The reaction is accompanied with crosslinking and/or extension of the molecular chains of the prepolymer. The reaction time is determined depending on the reactivity of the isocyanate group of the polyester prepolymer with the amine used, and is generally from 10 minutes to 40 hours, and preferably from 2 to 24 hours. The reaction temperature is generally from 0 to 150° C., and preferably from 40 to 98° C.

In addition, known catalysts such as dibutyltin laurate and tioctyltin layrate can be used, if desired, for the reaction.

(4) Removal of Organic Solvent and Washing and Drying

After the reaction, the organic solvent is removed from the emulsion (i.e., the reaction product), followed by washing and drying. Thus, toner particles are prepared. In order to remove the organic solvent, the emulsion is gradually heated while the emulsion is agitated so as to have a laminar flow. In this case, it is preferable to remove the solvent in a certain temperature range while strongly agitating the emulsion, so that the resultant toner particles have a spindle form. When a dispersant, which can be dissolved in an acid or an alkali, such as calcium phosphate is used, it is preferable to dissolve the dispersant with hydrochloric acid to remove that from the toner particles, followed by washing. In addition, it is possible to remove such a dispersant by decomposing the dispersant using an enzyme.

(5) Addition of External Additive

Then a charge controlling agent is fixed on the thus prepared toner particles and an external additive such as particulate inorganic materials (e.g., silica and titanium oxide) is added thereto. If desired, a particulate lubricant can also be added thereto. These materials can be added by a method using a known mixer or the like.

By using such a method, a toner having a small particle diameter and a sharp particle diameter distribution can be easily prepared. By controlling the agitation during the solvent removing operation, the particle form of the toner can be easily changed from spherical forms to rugby-ball forms. In addition, the surface conditions of the toner particles can be controlled so as to have a surface of from smooth surface to rough surface like pickled plum.

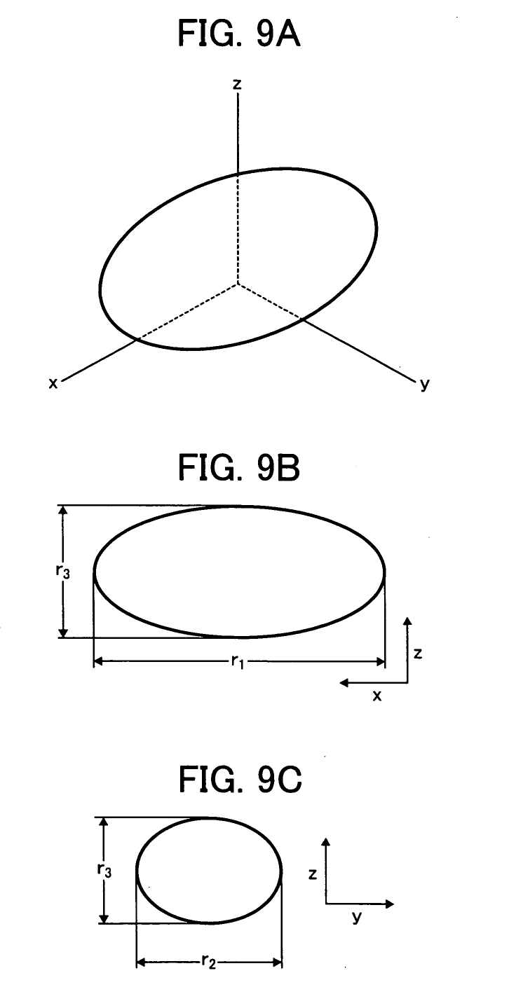

The toner for use in the present invention preferably has a form similar to the spherical form, and preferably satisfies the following relationships:
0.5≦(r2/r1)≦1.0 and 0.7≦(r3/r2)≦1.0,
wherein r1, r2 and r3 represent the average major axis particle diameter, the average minor axis particle diameter and the average thickness of particles of the toner, wherein r3≦r2≦r1. The major axis particle diameter, the minor axis particle diameter and the thickness of a toner are defined as illustrated in FIGS. 9A-9C.

When the ratio (r2/r1) is too small, the toner has a form far away from the spherical form, and therefore the toner has good cleanability, but the dot reproducibility and transfer efficiency deteriorate, resulting in deterioration of image qualities. In contrast, when the ratio (r2/r1) is too large, the toner has a form near the spherical form and therefore the cleaning problem tends to occur, particularly, under low temperature and low humidity conditions.

When the ratio (r3/r2) is too small, the toner has a flat form and therefore the toner does not cause the toner scattering problem because of being similar to a toner having an irregular form. However, such a toner is inferior to a spherical toner in transferability. In particular, when the ratio (r3/r2) is 1.0, the toner easily rotates on its major axis, resulting in improvement of the fluidity of the toner. Therefore the toner has good transferability and can produce high quality images. In addition, the toner can be well mixed with a carrier, and thereby the resultant two component developer has a narrow charge quantity distribution, thereby forming high definition images.

The above-mentioned size factors (i.e., r1, r2 and r3) of toner particles can be determined by observing the toner particles with a scanning electron microscope while the viewing angle is changed.

The thus prepared toner is used as a one component magnetic developer or a one component nonmagnetic developer or is used for a two component developer including the toner and a carrier.

When the toner is used for a two component developer, the toner is mixed with a magnetic carrier. Suitable materials for use as the magnetic carrier include particles of iron, magnetites and ferrites including a divalent metal such as Mn, Zn and Cu. The carrier preferably has a volume average particle diameter of from 20 to 100 μm. When the volume average particle diameter is too small, a problem in that carrier particles adhere to electrostatic latent images in a developing process occurs. In contrast, when the volume average particle diameter is too large, a problem in that the toner and the carrier are not well mixed, and thereby the toner is insufficiently charged with the carrier occurs, resulting in formation of images with poor image qualities. Among the carriers mentioned above, Cu-ferrites including Zn are preferably used because of having high saturation magnetization. However, a proper carrier is selected therefrom depending on the developing process used for the image forming apparatus for which the resultant developer is used.

The surface of the carrier is preferably coated with a resin. The coating resin is not particularly limited, but resins such as silicone resins, styrene—acrylic resins, fluorine-containing resins, and olefin resins are preferably used. The coating method is not particularly limited, but the following methods are preferably used:
(1) a resin solution in which a resin is dissolved in a solvent is sprayed on carrier particles, followed by drying; and
(2) a particulate resin is electrostatically adhered to carrier particles, followed by melting of the resin upon application of heat thereto.

The thickness of the coating resin is generally from 0.05 to 10 μm and preferably from 0.3 to 4 μm.

This document claims priority and contains subject matter related to Japanese Patent Applications Nos. 2004-345971 and 2005-022453, filed on Nov. 30, 2004, and Jan. 31, 2005, respectively, incorporated herein by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. An image forming apparatus comprising:
an image bearing member which is grounded and which is configured to bear an electrostatic latent image;
a charging device configured to charge the image bearing member by applying a DC voltage overlapped with an AC voltage to the image bearing member;
an AC current detector configured to detect an AC current flowing through the image bearing member on a ground side of the image bearing member;
a light irradiating device configured to irradiate the charged image bearing member with imagewise light to form the electrostatic latent image on the image bearing member;
a developing device configured to develop the electrostatic latent image with a developer comprising a toner to form a toner image on the image bearing member;
a transferring device configured to transfer the toner image onto a receiving material;
a cleaning device configured to clean a surface of the image bearing member.

2. The image forming apparatus according to claim 1, further comprising:
a controller configured to perform an AC voltage controlling operation in which a plurality of constant-voltage alternating peak-to-peak voltages having different voltages are applied to the charging device one by one while checking the respective currents to determine a minimum AC current which is smallest among currents being not lower than a threshold current, above which a potential of the charged image bearing member is substantially constant; and then the AC voltage applied to the charging device is set to an AC voltage corresponding to the minimum AC current.

3. The image forming apparatus according to claim 2, wherein the controller performs the AC voltage controlling operation when an absolute humidity of air surrounding the charging device is changed.

4. The image forming apparatus according to claim 2, wherein the controller performs the AC voltage controlling operation when the toner image is not formed for a predetermined time.

5. The image forming apparatus according to claim 2, wherein the controller performs the AC voltage controlling operation after the toner image is formed on a predetermined number of sheets of the receiving material.

6. The image forming apparatus according to claim 1, further comprising:
a controller configured to perform an AC voltage controlling operation in which a plurality of 1-cycle AC currents are checked when the AC voltage is applied, to determine a minimum AC current among the plurality of 1-cycle AC currents; and then the AC voltage applied to the charging device is adjusted so as to be an AC voltage such that the minimum AC current is not lower than a threshold AC current, below which the toner image has background fouling.

7. The image forming apparatus according to claim 6, wherein the controller performs the AC voltage controlling operation when an-absolute humidity of air surrounding the charging device is changed.

8. The image forming apparatus according to claim 6, wherein the controller performs the AC voltage controlling operation when the toner image is not formed for a predetermined time.

9. The image forming apparatus according to claim 6, wherein the controller performs the AC voltage controlling operation after the toner image is formed on a predetermined number of sheets of the receiving material.

10. The image forming apparatus according to claim 1, further comprising:
a lubricant applicator configured to apply a first lubricant on a surface of the image bearing member.

11. The image forming apparatus according to claim 10, wherein the lubricant applicator comprises a brush roller configured to scrape the lubricant to apply the first lubricant to the surface of the image bearing member.

12. The image forming apparatus according to claim 10, wherein the toner comprises a second lubricant which is the same as or different from the first lubricant.

13. The image forming apparatus according to claim 10, wherein the first lubricant is one member selected from the group consisting of fatty acid metal salts and fluorine containing materials.

14. The image forming apparatus according to claim 1, wherein the toner has a volume average particle diameter (Dv) of from 3 to 8 μm, and a ratio (Dv/Dn) of the volume average particle diameter (Dv) to a number average particle diameter (Dn) of from 1.00 to 1.40.

15. The image forming apparatus according to claim 1, wherein the toner has a first shape factor SF-1 of from 100 to 180 and a second shape factor of from 100 to 180.

16. The image forming apparatus according to claim 1, wherein the toner is prepared by a method comprising:
dispersing or dissolving at least a polyester prepolymer having a functional group having a nitrogen atom, a polyester, a colorant and a release agent in an organic solvent to prepare a toner composition liquid; and
subjecting the toner composition liquid to one reaction selected from the group consisting of crosslinking reactions, extension reactions and combinations thereof in an aqueous medium.

17. The image forming apparatus according to claim 1, wherein the toner satisfies the following relationships:
0.5≦(r2/r1)≦1.0 and 0.7≦(r3/r2)≦1.0,
wherein r1, r2 and r3 represent an average major axis particle diameter, ane average minor axis particle diameter and an average thickness of particles of the toner, wherein r3≦r2≦r1.

18. A toner for use in the image forming apparatus according to claim 1, wherein the toner has a volume average particle diameter (Dv) of from 3 to 8 μm, and a ratio (Dv/Dn) of the volume average particle diameter (Dv) to a number average particle diameter (Dn) of from 1.00 to 1.40.

19. The toner according to claim 18, wherein the toner has a first shape factor SF-1 of from 100 to 180 and a second shape factor of from 100 to 180.

20. The toner according to claim 18, wherein the toner is prepared by a method comprising:
dispersing or dissolving at least a polyester prepolymer having a functional group having a nitrogen atom, a polyester, a colorant and a release agent in an organic solvent to prepare a toner composition liquid; and
subjecting the toner composition liquid to one reaction selected from the group consisting of crosslinking reactions, extension reactions and combinations thereof in an aqueous medium.

21. The toner according to claim 18, wherein the toner satisfies the following relationships:
0.5≦(r2/r1)≦1.0 and 0.7≦(r3/r2)≦1.0,
wherein r1, r2 and r3 represent the average major axis particle diameter, the average minor axis particle diameter and the average thickness of particles of the toner, wherein r3≦r2≦r1.

22. A process cartridge comprising:
an image bearing member which is grounded and which is configured to bear an electrostatic latent image;
a charging device configured to charge the image bearing member by applying a DC voltage overlapped with an AC voltage to the image bearing member; and
an AC current detector configured to detect an AC current flowing through the image bearing member an a ground side of the image bearing member.
wherein the image bearing member, the charging device and the AC current detector are unitized.

23. An image forming method comprising:
applying a DC voltage overlapped with an AC voltage to an image bearing member which is grounded to charge the image bearing member;
detecting an AC current on a ground side of the image bearing member;
irradiating the charged image bearing member with imagewise light to forman electrostatic latent image on a surface of the image bearing member; and
developing the electrostatic latent image with a developer comprising a toner to form a toner image on the surface of the image bearing member.

24. The image forming method according to claim 23, further comprising:
performing an AC voltage controlling operation comprising:
applying a plurality of constant-voltage alternating peak-to-peak voltages having different voltages to the image bearing member one by one while checking the respective currents to determine a minimum AC current which is smallest among currents being not lower than a threshold current, above which a potential of the charged image bearing member is substantially constant; and
setting the AC voltage applied to the charging device to an AC voltage corresponding to the minimum AC current.

25. The image forming method according to claim 23, further comprising:
performing an AC voltage controlling operation comprising:
checking a plurality of 1-cycle AC currents of the AC voltage to determine a minimum AC current among the plurality of 1-cycle AC currents; and
setting the AC voltage so as to be an AC voltage such that the minimum AC current is not lower than a threshold AC current, below which the toner image has background fouling.
